(19) United States
(12) Patent Application Publication
(10) Pub. No.: US 2025/0384546 A1
(43) Pub. Date: Dec. 18, 2025

(54) SYSTEM AND METHOD FOR RAILWAY FOREIGN OBJECT DETECTION

(71) Applicant: City University of Hong Kong, Kowloon (HK)

(72) Inventors: Tiange WANG, Shanghai (CN); Xinuo ZHAO, Kowloon (HK); Zijun ZHANG, Kowloon Tong (HK)

(73) Assignee: City University of Hong Kong, Kowloon (HK)

(21) Appl. No.: 18/910,186

(22) Filed: Oct. 9, 2024

Related U.S. Application Data
(60) Provisional application No. 63/661,339, filed on Jun. 18, 2024.

(51) Int. Cl. G06T 7/00; G06T 11/00

(52) U.S. Cl. CPC G06T 7/001; G06T 11/003; G06T 2207/20084

(57) ABSTRACT

A computer-implemented system for foreign object detection in a scene. The system includes a memory-suppress diffusion network module adapted to reconstruct a reconstructed image from an encoded image, and a contrastive dissimilarity network adapted to combine the input image and the reconstructed image to predict an anomaly map for the input image. The encoded image is based on an input image, and the memory-suppress diffusion network module and the contrastive dissimilarity network are trained using only normal, real images. The system leverages only normal images in training and does not compromise the detection performance at the inference stage.

### CROSS-REFERENCE TO RELATED APPLICATION

This application claims priority to and the benefit of U.S. Provisional Patent Application No. 63/661,339 filed in the United States Patent and Trademark Office on Jun. 18, 2024, the entire contents of which are incorporated herein by reference.

### FIELD OF INVENTION

This invention relates to machine visions, for example those used for foreign object detections in a scene.

### BACKGROUND OF INVENTION

In railway contexts, ensuring safety and operational efficiency heavily relies on the detection of anomalies, particularly foreign objects on rail tracks. Manual inspection often falls short in meeting the demands of high precision and efficiency necessitated by the advancements in industrial intelligence. Recent attention has been directed towards anomaly detection in computer vision using machine/deep learning models. Various methodologies aim to classify normal and anomalous images within railway settings.

Despite these efforts, challenges persist in achieving reliable and effective foreign object detection due to the specific characteristics of railway anomalies. The following discussion delves into these challenges in detail:

(1) Limited accessibility of field data. The accumulation and retention of extensive data hold the potential for enhancing analysis and facilitating immediate insights using progressive data-driven methods. However, the lack of publicly accessible field data presents a significant barrier. Concerns on the data privacy, intellectual property rights, and logistical challenges of managing and sharing valuable resources often lead to the non-disclosure of datasets. Consequently, gaining access to authentic anomalous data becomes a serious impediment, hindering the development of effective anomaly detection techniques.

(2) Limited availability of anomalous images. Anomalies in industrial environments are often sporadic and infrequent, resulting in a scarcity of anomalous images for training and evaluation purposes. Although a subset of defective images can be obtained, the inherent imbalance between anomalous and normal instances poses a significant challenge. Such scarcity underscores the importance of innovative approaches that can effectively utilize limited data resources and address class imbalance issues.

(3) Imprecise outcomes of anomaly detection. Precise anomaly detection requires distinguishing between normal and anomalous instances at both image and pixel levels. However, obtaining pixel-wise annotations for anomaly detection presents formidable challenges. The manual annotation process is labor-intensive, time-consuming, and prone to human errors, introducing biases and inaccuracies in the labeling process. Such imprecision undermines the reliability and effectiveness of anomaly detection systems in real-world applications, where accurate anomaly localization is critical for timely intervention and decision-making.

Therefore, in conventional art applying machine vision to facilitate railway anomaly detections faces a grand challenge that anomalous samples for model training are insufficient due to their infrequent occurrence and wide diversity.

### REFERENCES

All referenced literatures throughout this disclosure are incorporated herein by reference in their entirety, which include the following references:
[1]D. Morandi and S. Jingling, “Anomaly Detection in Railway Infrastructure,” in AAAI Spring Symp. Comb. Mach. Learn. Knowl. Eng., 2021.
[2]D. Zhang, K. Song, Q. Wang, Y. He, X. Wen, and Y. Yan, “Two deep learning networks for rail surface defect inspection of limited samples with line-level label,” IEEE Trans. Ind. Inform., vol. 17, no. 10, pp. 6731-6741, 2020.
[3]X. Ni, Z. Ma, J. Liu, B. Shi, and H. Liu, “Attention network for rail surface defect detection via consistency of intersection-over-union (IoU)-guided center-point estimation,” IEEE Trans. Ind. Inform., vol. 18, no. 3, pp. 1694-1705, 2021.
[4]X. Wei, Z. Yang, Y. Liu, D. Wei, L. Jia, and Y. Li, “Railway track fastener defect detection based on image processing and deep learning techniques: A comparative study,” Eng. Appl. Artif. Intel., vol. 80, pp. 66-81, 2019.
[5]L. Zhuang, H. Qi, T. Wang, and Z. Zhang, “A Deep-Learning-Powered Near-Real-Time Detection of Railway Track Major Components: A Two-Stage Computer-Vision-Based Method,” IEEE Internet Things J., vol. 9, no. 19, pp. 18806-18816, 2022.
[6]C. Chen, K. Li, C. Zhongyao, F. Piccialli, S. C. Hoi, and Z. Zeng, “A hybrid deep learning based framework for component defect detection of moving trains,” IEEE Trans.

Intell. Transp. Syst., vol. 23, no. 4, pp. 3268-3280, 2020.
[7]T. Wang, Z. Zhang, and K.-L. Tsui, “A Deep Generative Approach for Rail Foreign Object Detections via Semisupervised Learning,” IEEE Trans. Ind. Inform., vol. 19, no. 1, pp. 459-468, 2022.
[8]Z. Liu, L. Wang, C. Li, and Z. Han, “A high-precision loose strands diagnosis approach for isoelectric line in high-speed railway,” IEEE Trans. Ind. Inform., vol. 14, no. 3, pp. 1067-1077, 2017.
[9]J. Zhong, Z. Liu, C. Yang, H. Wang, S. Gao, and A. Ndnez, “Adversarial reconstruction based on tighter oriented localization for catenary insulator defect detection in high-speed railways,” IEEE Trans. Intell. Transp. Syst., vol. 23, no. 2, pp. 1109-1120, 2020.
[10]Y. Zhang, M. Liu, Y. Yang, Y. Guo, and H. Zhang, “A unified light framework for real-time fault detection of freight train images,” IEEE Trans. Ind. Inform., vol. 17, no. 11, pp. 7423-7432, 2021.
[11]Y. Wu, Y. Qin, Y. Qian, F. Guo, Z. Wang, and L. Jia, “Hybrid deep learning architecture for rail surface segmentation and surface defect detection,” Comput.-Aided Civ. Infrastruct. Eng., vol. 37, no. 2, pp. 227-244, 2022.
[12]P. Bergmann, S. Löwe, M. Fauser, D. Sattlegger, and C. Steger, “Improving unsupervised defect segmentation by applying structural similarity to autoencoders,” arXiv preprint arXiv:1807.02011, 2018.
[13]T. Schlegl, P. SeebOck, S. M. Waldstein, G. Langs, and U. Schmidt-Erfurth, “f-anogan: Fast unsupervised anomaly detection with generative adversarial networks,” Med.

Image Anal., vol. 54, pp. 30-44, 2019.
[14]S. Akcay, A. Atapour-Abarghouei, and T. P. Breckon, “Ganomaly: Semi-supervised anomaly detection via adversarial training,” in Asian Conf. Comput. Vis., 2018: Springer, pp. 622-637.
[15]V. Zavrtanik, M. Kristan, and D. Skocaj, “Reconstruction by inpainting for visual anomaly detection,” Pattern Recognit., vol. 112, p. 107706, 2021.
[16]X. Yan, H. Zhang, X. Xu, X. Hu, and P.-A. Heng, “Learning semantic context from normal samples for unsupervised anomaly detection,” in Proc. AAAI Conf. Artif.

Intel., 2021, vol. 35, no. 4, pp. 3110-3118.
[17]J. Yang, R. Xu, Z. Qi, and Y. Shi, “Visual anomaly detection for images: A systematic survey,” Procedia Comput. Sci., vol. 199, pp. 471-478, 2022.
[18]J. Ho, A. Jain, and P. Abbeel, “Denoising diffusion probabilistic models,” Adv.

Neural Inf. Process. Syst., vol. 33, pp. 6840-6851, 2020.
[19]A. Q. Nichol and P. Dhariwal, “Improved denoising diffusion probabilistic models,” in Int. Conf. Mach. Learn., 2021: PMLR, pp. 8162-8171.
[20]J. Wyatt, A. Leach, S. M. Schmon, and C. G. Willcocks, “Anoddpm: Anomaly detection with denoising diffusion probabilistic models using simplex noise,” in Proc. IEEE/CVF Conf. Comput. Vis. Pattern Recognit., 2022, pp. 650-656.
[21]C. Lu, Y. Zhou, F. Bao, J. Chen, C. Li, and J. Zhu, “DPM-Solver++: Fast Solver for Guided Sampling of Diffusion Probabilistic Models,” arXiv preprint arXiv:2211.01095, 2022.
[22]C. Lu, Y. Zhou, F. Bao, J. Chen, C. Li, and J. Zhu, “Dpm-solver: A fast ode solver for diffusion probabilistic model sampling in around 10 steps,” Adv. Neural Inf.

Process. Syst., vol. 35, pp. 5775-5787, 2022.
[23]P. de Haan and S. LUwe, “Contrastive predictive coding for anomaly detection,” arXiv preprint arXiv:2107.07820, 2021.
[24]A. Radford, J. W. Kim, C. Hallacy, A. Ramesh, G. Goh, S. Agarwal, G. Sastry, A. Askell, P. Mishkin, and J. Clark, “Learning transferable visual models from natural language supervision,” in Int. Conf. Mach. Learn., 2021: PMLR, pp. 8748-8763.
[25]A. v. d. Oord, Y. Li, and O. Vinyals, “Representation learning with contrastive predictive coding,” arXiv preprint arXiv:1807.03748, 2018.
[26]P. Bachman, R. D. Hjelm, and W. Buchwalter, “Learning representations by maximizing mutual information across views,” Adv. Neural Inf. Process. Syst., vol. 32, 2019.
[27]K. He, H. Fan, Y. Wu, S. Xie, and R. Girshick, “Momentum contrast for unsupervised visual representation learning,” in Proc. IEEE/CVF Conf. Comput. Vis.

Pattern Recognit., 2020, pp. 9729-9738.
[28]X. Chen and K. He, “Exploring simple siamese representation learning,” in Proc. IEEE/CVF Conf. Comput. Vis. Pattern Recognit., 2021, pp. 15750-15758.
[29]J.-B. Grill, F. Strub, F. Altché, C. Tallec, P. Richemond, E. Buchatskaya, C. Doersch, B. Avila Pires, Z. Guo, and M. Gheshlaghi Azar, “Bootstrap your own latent-a new approach to self-supervised learning,” Adv. Neural Inf. Process. Syst., vol. 33, pp. 21271-21284, 2020.
[30]J. Zbontar, L. Jing, I. Misra, Y. LeCun, and S. Deny, “Barlow twins: Self-supervised learning via redundancy reduction,” in Int. Conf. Mach. Learn., 2021: PMLR, pp. 12310-12320.
[31]E. R. DeLong, D. M. DeLong, and D. L. Clarke-Pearson, “Comparing the areas under two or more correlated receiver operating characteristic curves: a nonparametric approach,” Biom., pp. 837-845, 1988.
[32]B. Li, F. Wu, S.-N. Lim, S. Belongie, and K. Q. Weinberger, “On feature normalization and data augmentation,” in Proc. IEEE/CVF Conf. Comput. Vis. Pattern Recognit., 2021, pp. 12383-12392.
[33]G. Fang, K. Mo, X. Wang, J. Song, S. Bei, H. Zhang, and M. Song, “Up to 100× faster data-free knowledge distillation,” in Proc. AAAI Conf. Artif. Intel., 2022, vol. 36, no. 6, pp. 6597-6604.
[34]G. Fang, J. Song, C. Shen, X. Wang, D. Chen, and M. Song, “Data-free adversarial distillation,” arXiv preprint arXiv:1912.11006, 2019.

### SUMMARY OF INVENTION

In the light of the foregoing background, it is an object of the present invention to focuses on the above-mentioned weakness and propose alternative machine vision-powered railway foreign object detection (RFOD) systems and methods.

The above object is met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

Accordingly, the present invention in one aspect is a computer-implemented system for foreign object detection in a scene. The system includes a memory-suppress diffusion network module adapted to reconstruct a reconstructed image from an encoded image, and a contrastive dissimilarity network adapted to combine the input image and the reconstructed image to predict an anomaly map for the input image. The encoded image is based on an input image, and the memory-suppress diffusion network module and the contrastive dissimilarity network are trained using only normal, real images.

In some embodiments, the memory-suppress diffusion network module further includes a noise encoding module adapted to generate a plurality of noise-perturbed images from the input image, a normality memorizing module adapted to integrate a set of code memories to establish consistent representations of normality, and a denoise memory-suppress sampling module adapted to reconstruct the reconstructed image from the consistent representations of normality using memory-suppression techniques. The set of code memories is obtained from an output of the noise encoding module.

In some embodiments, the plurality of noise-perturbed images is generated with a steadily increasing noise level.

In some embodiments, the noise levels of the plurality of noise-perturbed images follow a Markovian process, and sizes of steps of the noise levels are dominated by a variance scheduler.

In some embodiments, the noise encoding module is further adapted to sample a latent noisy at an arbitrary time step.

In some embodiments, the normality memorizing module is adapted to transform a feature vector associated with one said noise-perturbed image using a corresponding one of the code memories.

In some embodiments, during the transforming, the normality memorizing module is further adapted to compute a cosine similarity between the feature vector and the corresponding one of the code memories.

In some embodiments, a Softmax function is used to obtains weights in computation of the cosine similarity.

In some embodiments, the normality memorizing module is adapted to transform all the feature vectors associated with the plurality of noise-perturbed images to obtain a feature map.

In some embodiments, the normality memorizing module is adapted to update a memory query using a feature map.

In some embodiments, the denoise memory-suppress sampling module is adapted to reconstruct the reconstructed image using knowledge of all previous gradients.

In some embodiments, the contrastive dissimilarity network includes an encoder adapted to encode the input image and the reconstructed image to obtain two embedding vectors, a projector adapted to project the two embedding vectors to a larger space, and a fusion block adapted to compute a correlation map from an output of the projector.

In some embodiments, the encoder is a pre-trained VGG (Visual Geometry Group) model.

In some embodiments, the projector is a three-layer perceptron with batch normalization and ReLU (rectified linear unit) activation.

In some embodiments, the system is adapted to provide a weighted dissimilarity score to express the foreign object detection at image-level.

In some embodiments, the system is adapted to generate a stacked pixel-wise anomaly map by merging a score distance map and a feature distance map along a depth dimension.

In some embodiments, the memory-suppress diffusion module and the contrastive dissimilarity network are jointly optimized during training.

According to another aspect of the invention, there is provided a computer-implemented method for detecting a foreign object. The method includes the steps of encoding an input image to obtain an encoded image, reconstructing a reconstructed image from the encoded image using a memory-suppress diffusion network module, and combing the input image and the reconstructed image to predict an anomaly map for the input image. The memory-suppress diffusion network module and the contrastive dissimilarity network are trained using only normal, real images.

In some embodiments, the step of encoding the input image further includes a step of generating a plurality of noise-perturbed images from the input image.

In some embodiments, the step of reconstructing the reconstructed image includes integrating a set of code memories to establish consistent representations of normality, and reconstructing the reconstructed image from the consistent representations of normality using memory-suppression techniques. The set of code memories is obtained from an output of the step of encoding the input image.

In some embodiments, the step of combing the input image and the reconstructed image to predict an anomaly map for the input image, includes encoding the input image and the reconstructed image to obtain two embedding vectors, projecting the two embedding vectors to a larger space; and computing a correlation map from an output of the previous step.

According to another aspect of the invention, there is provided a non-transitory computer-readable medium, which has stored thereon program instructions that, upon execution by a computing device, cause the computing device to perform the methods as described above.

According to a further aspect of the invention, there is provide a computing system including one or more processors; and a memory containing instructions that, when executed by the one or more processors, cause the computing system to perform the method according to the methods mentioned above.

In another aspect of the invention, there is provided a method for a novel approach called anomaly-free representation learning approach (ARLA) for solving the problem in the field of RFOD. The method includes the steps of using the memory-suppress diffusion module to reconstruct the input images; designing the contrastive dissimilarity network to measure anomaly maps between input and reconstruction and provide image-level and pixel-wise detection results; defining the training mechanism and illustrating the test procedure to handle different anomalies in railway scenes.

In some embodiments, the memory-suppress diffusion module has three essential steps as noise encoding, normality memorizing and denoise memory-suppress sampling.

In some embodiments, the latent noisy can be sampled at arbitrary time step, which is further used to calculate the tractable objective loss.

In some embodiments, the normality memorizing step serves both transform the feature vector and update the memory query.

In some embodiments, the method uses Softmax function to get the corresponding weights.

In some embodiments, the method uses cosine function to compute the similarity between each memory query and the encoded feature map.

In some embodiments, the reconstruction in denoise sampling step requires the knowledge of all previous gradients.

In some embodiments, the contrastive dissimilarity network has three main components including an encoder, a projector, and a fusion block.

In some embodiments, the invention utilizes a pre-trained VGG (Visual Geometry Group); as the encoder to process both original input and the reconstruction, resulting in two embedding vectors.

In some embodiments, the design of the vector projection is common and crucial in CRL-based (contrastive representation learning-based) methods.

In some embodiments, the fusion block directs the network to pay attention to high-dissimilar areas in the correlation map.

In some embodiments, the objective function of the contrastive dissimilarity network involves both achieving effective differentiation between the input image and its corresponding reconstruction and a point-wise correlation with the high-level embedding vectors.

In some embodiments, the ARLA defines a weighted dissimilarity score ξ(x) to express the RFOD at image-level.

In some embodiments, the ARLA generates a stacked pixel-wise anomaly map by merging a score distance map and a feature distance map along the depth dimension.

Embodiments of the invention therefore provide the ARLA which incorporates anomaly rejection mechanisms into the learning process. The anomaly rejection mechanisms in ARLA ensures that the learned representations predominantly capture normal or non-anomalous patterns, effectively minimizes the influence of outliers or noise in the training data, resulting in more robust and reliable representations. Besides, ARLA offers versatility by providing both image-level and pixel-wise detection results, which enhances the utility of ARLA in real-world applications, where precise anomaly localization is crucial for effective decision-making and intervention.

### BRIEF DESCRIPTION OF FIGURES

The foregoing and further features of the present invention will be apparent from the following description of preferred embodiments which are provided by way of example only in connection with the accompanying figures, of which:

FIG. 1a shows a normal rail image that is well reconstructed by memory-suppress diffusion.

FIG. 1b shows that an anomalous rail image is reconstructed with the normal patterns recorded in memory-suppress diffusion.

FIG. 2 shows the overall architecture of an ARLA according to a first embodiment of the invention.

FIG. 3 illustrates the architecture of the memory-suppress diffusion module in the ARLA of FIG. 2.

FIG. 4a illustrates collected samples from Dₜᵣₐᵢₙ.

FIG. 4b illustrates collected samples from Dₜₑₛₜ.

FIG. 5a illustrates sensitivity analysis of weight parameter λ.

FIG. 5b illustrates sensitivity analysis of weight parameters ω.

FIG. 6a compares training losses of the ARLA with benchmark methods.

FIG. 6b compares validation losses of the ARLA with benchmark methods.

FIG. 7a shows the F1-score comparisons of ARLA and benchmarking methods.

FIG. 7b shows the dice coefficient comparisons of ARLA and benchmarking methods.

FIG. 7c shows the mIoU comparisons of ARLA and benchmarking methods.

FIG. 8 is a table showing comparison with two groups of benchmarking methods.

FIG. 9 shows visualization of activation maps in neural networks.

FIG. 10 shows the receiver operating characteristic (ROC) curves and p-values via DeLong's test.

FIG. 11 shows data augmentation samples and their visualized detection results from D_{aug}.

FIG. 12a is a histogram of all anomalous images in D_{aug}, where anomaly severity is categorized into four levels: <10%, 10-20%, 20-30%, and >30%.

FIG. 12b shows ROC curves and AUROC of four anomaly severity levels.

FIG. 12c illustrates trade-off between computational efficiency and detection performance based on Dₜₑₛₜ.

### DETAILED DESCRIPTION OF THE PREFERRED EMBODIMENTS

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein and in the claims, “couple” or “connect” refers to electrical coupling or connection either directly or indirectly via one or more electrical means unless otherwise stated. When describing a “direct connection”, it means two circuit components, nodes, or terminals are connected to each other without any intermediate components therebetween.

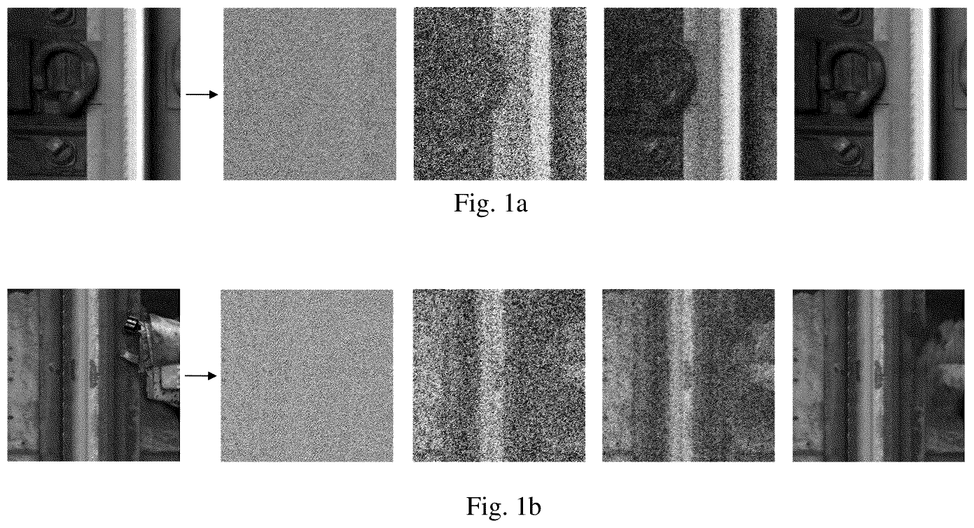

Embodiments of the invention focus on the field of RFOD and introduce the ARLA. The ARLA addresses challenges in the conventional art by incorporating anomaly rejection mechanisms into the learning process. One of the key advantages of ARLA is that its training is free of anomalous samples at the representation learning stage. The anomaly rejection mechanism in ARLA ensures that the learned representations predominantly capture normal or non-anomalous patterns. This approach effectively minimizes the influence of outliers or noises in the training data, resulting in more robust and reliable representations. Moreover, during the testing phase, ARLA offers versatility by providing both image-level and pixel-wise detection results. Such a capability enables ARLA to offer comprehensive insights into the presence and location of anomalies contained in railway images. Image-level detection results provide an overall assessment of anomaly presence, while pixel-wise detection results offer finer-grained information, pinpointing the exact locations of anomalies within the image. This comprehensive detection capability enhances the utility of ARLA in real-world applications, where precise anomaly localization is crucial for effective decision-making and intervention. FIGS. 1a-1b provide a visual depiction of the motivation for the ARLA in the context of anomalous railway scenes.

As such, exemplary embodiments of the invention present a pioneering attempt for formulating RFOD as an anomaly-free representation learning process, which aims to address the challenge of limited anomalous data in railway contexts. A novel memory-suppress diffusion process that captures the prototypical patterns of normal data in ARLA is introduced. By quantizing code memories, the reconstruction of images is enhanced excessive model generalization is prevented, thereby improving the accuracy of RFOD. A novel dissimilarity loss function is proposed to develop the contrastive dissimilarity network in ARLA. It ensures the discriminative power between the input and its reconstruction, enabling both image-level and pixel-wise detection results. The ARLA offers a new state-of-the-art performance for RFOD, which is verified via computational experiments conducted on a collected real dataset. Ablation studies are also conducted to justify the effectiveness and superiority of each component in ARLA.

Before describing exemplary embodiments of the invention, some related works will be briefly mentioned below. In the field of RFOD, extensive research has been conducted on the task of classifying and segmenting anomalous instances within images. There are approaches developed specifically for image-level anomaly detection in railway infrastructure, and there are methods that have been generalized to handle pixel-wise anomaly detection on widely recognized public datasets. Due to the complexity and numerous subcomponents within railway infrastructure, there exists a broad spectrum of research areas dedicated to anomaly detection in this domain. Existing methods primarily focus on identifying anomalous scenes related to rail tracks, rolling stock, and catenary systems [1]. Maintenance tasks for railway infrastructure can be broadly classified into two main categories, the surface defect detection (such as cracks and corrugations on rails [2, 3], defects on fasteners [4], etc.) and anomaly inspection (such as broken/missing parts [5, 6], foreign objects/obstacles [7], anomalies in components [8, 9], etc.). The image data employed in these research endeavors are often acquired through custom systems and meticulously hand-labeled, thus limiting their public availability.

Considering the scale and availability of the image data, some studies leverage the third-party data to pre-train the model and adopt transfer learning approaches [2, 10]. Pre-trained models serve as the initial learning point, preserving computational resources and enhancing overall detection performance. During the inference stage, many studies focus on image-level anomaly detection in railway infrastructure while neglecting the localization of anomalies. To address this limitation, segmentation tasks aim to precisely assign pixels within input images to anomalous regions [4, 11]. The output is a segmentation map with the same size as the input image, which facilitates subsequent diagnosis and maintenance. Nevertheless, the segmentation of anomalies is usually implemented in a supervised manner, calling for more advanced data-driven solutions to perform pixel-wise anomaly detection when limited anomalous image data is available.

As a typical type of method for anomaly detection, deep generative models strive to compress and reconstruct the normal images and detect the potential anomalies by evaluating the pixel differences between the inputs and their reconstructions. AE-based [12]methods and GAN-based methods [13, 14] have been widely employed in industrial image analysis, exhibiting promising results in anomaly localization. Typically, the learning process of these methods follows a semi-supervised manner, assuming that only normal image representations are learned. During testing, the models struggle to reconstruct anomalous images as accurately as normal ones, providing an opportunity for anomaly detection. In addition to commonly used distance metrics [13, 15], reconstruction probability [12] and likelihood score [16] are defined as supplementary anomaly measures.

AE-based methods possess a strong theoretical foundation, but designing an effective loss function remains challenging, resulting in suboptimal reconstructions. GAN-based methods perform well in various applications, yet they face issues such as training difficulties, vanishing gradients, model collapse, and limited diversity in generated outputs. In summary, generating high-quality images for comparisons is a daunting task, as reconstructing sharp edges and complex texture characteristics often proves challenging, leading to a high number of false abnormal alarms [17].

Denoising diffusion probabilistic models (DDPMs) [18], originating from probabilistic likelihood estimation methods, have recently emerged as powerful tools in computer vision tasks, particularly in generative modeling. DDPMs excel in generating high-quality and diverse samples through forward and reverse diffusion stages [19]. They incorporate a vast amount of images and utilize multi-scale representations from the diffusion decoder [20]. Compared with AE- and GAN-based methods, DDPMs offer both tractability and flexibility in analytically evaluating and fitting arbitrary data structures. They possess advantages over alternative generative models when dealing with smaller datasets, as they provide improved sample quality and a stable training scheme. Furthermore, the continuous advancements in sampling speed of DDPMs (requiring significantly fewer sampling steps, up to hundreds of times faster) demonstrate their potential in terms of time efficiency and computational cost [21, 22].

The ability of learning latent representations of raw input data establishes a connection to the broader domain of representation learning. As one of the powerful approaches in self-supervised learning, contrastive representation learning (CRL) has shown promising results in capturing shared features among similar images while distinguishing differences among dissimilar images [23].

The main idea of CRL is to define a similarity distribution that maps the similar pairs close and the dissimilar samples far apart in the embedding space. Unlike the supervised approaches, CRL defines similarity based on the data itself, thereby alleviating the reliance on a labeled dataset with a substantial number of anomalies. Nevertheless, if additional labels are available, CRL can be flexibly integrated into a supervised detection framework [24]. As a result, CRL offers a straightforward yet potent means to learn representations in both supervised and self-supervised settings.

Previous research has developed notable CRL-based methods, including CPC [25], AMDIM [26], and MoCo [27]. These methods aim to learn features for effectively distinguishing training samples from other samples rather than focus on capturing every detail of training samples, which is a major difference from the GAN-based methods. Progressive methods enhance their robustness by relying less on negative pairs through asymmetric structures [28][29] or novel objective function [30].

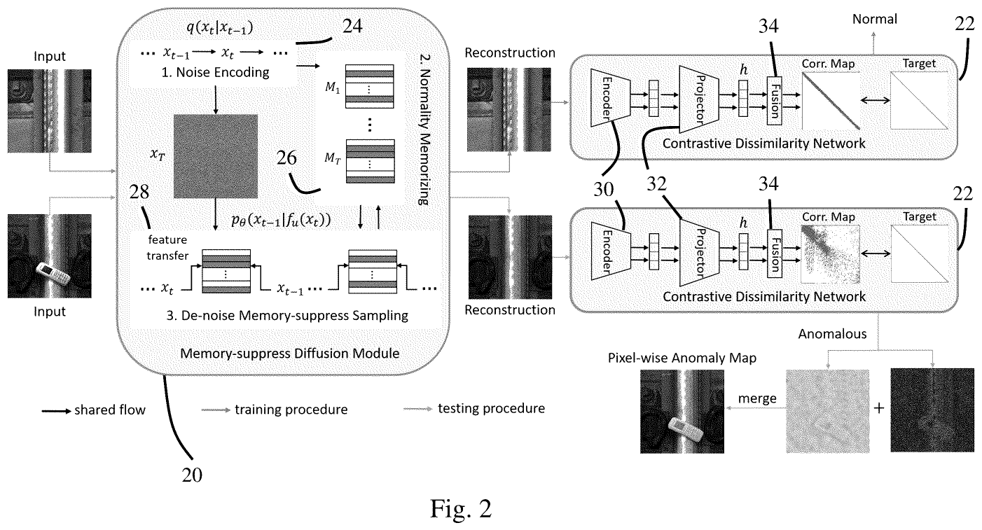

Next, the detailed structure of the ARLA according to an exemplary embodiment of the invention will described. The overview of ARLA is illustrated in FIG. 2. The ARLA is implemented on a computer system, and includes a memory-suppress diffusion module 20 and a contrastive dissimilarity network 22. The memory-suppress diffusion module 20 is configured for reconstructing input images, and the contrastive dissimilarity network 22 is used to measure anomaly maps between input and reconstruction, providing image-level and pixel-wise detection results. The training mechanism of the ARLA will be described later, along with its testing procedure, which handles different anomalies in railway scenes.

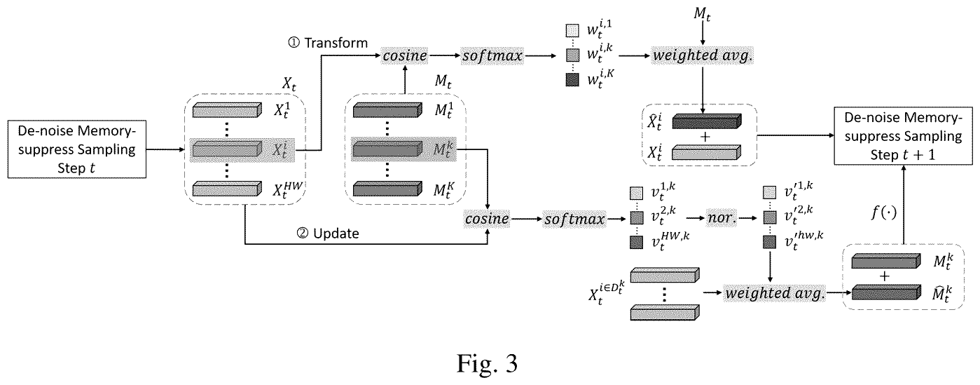

First of all, Table I below defines main notations that are shown in FIG. 2 and FIG. 3 and which will be used to described components of the ARLA.

TABLE I
TABLE OF NOTATIONS

| Notation | Description |
|---|---|
| x | Input image |
| X | Image features |
| q, p | Density distribution |
| β | Variance scheduler |
| t, T | Time step |
| M | code memory |
| w, v | Corresponding weights |
| h | Projector output |
| C | Correlation map |
| ε(x) | Dissimilarity score |
| Mₛ, M_{d} | Distance map |
| [symbol] _{vlb} | Variational lower bound loss |
| [symbol] ₛ | Noise loss |
| [symbol] _{d} | Contrastive dissimilarity loss |

The memory-suppress diffusion module 20 comprises three modules, namely a noise encoding module, a normality memorizing module, and a denoise memory-suppress sampling module. The noise encoding module carries out a noise encoding step 24 which follows the basic diffusion process in DDPM to generate a sequence of noise-perturbed images [18]. Next, a set of code memories obtained from the previous step is integrated to establish consistent representations of normality in a normality memorizing step 26 carried out by the normality memorizing module. Lastly, the denoise memory-suppress sampling module carries out a denoise memory-suppress sampling step 28 which continuously reconstructs the normal railway images from the Gaussian noise input using memory-suppression techniques.

The goal of the noise encoding step 24 which follows the basic diffusion process in DDPM is to produce a sequence of noisy images {x₁, x₂, . . . , x_{T}}given an input image x₀ from the real image dataset with density distribution x₀˜q(x₀). The noise level of the image is steadily increased in T steps, which follows the Markovian process:

$$q ( {x}_{t} \vert {x}_{t - 1} ) = 𝒩 ( {x}_{t} ; \sqrt{1 - {β}_{t}} {x}_{t - 1} , {β}_{t} I ) , ∀ t ∈ \{ 1 , … , T \} \qquad ( 1 )$$

$$q ( {x}_{1 : T} \vert {x}_{0} ) = {\prod }_{t = 1}^{T} q ( {x}_{t} \vert {x}_{t - 1} ) \qquad ( 2 )$$

where the step sizes are dominated by a variance scheduler

$${\{ {β}_{t} ∈ ( 0 , 1 ) \}}_{t = 1}^{T} .$$

Usually, a larger update step is obtained when the image becomes noisier and thereby β₁<β₂< . . . <β_{T}. I is the identity matrix with the same dimension as x₀. The normal distribution [symbol] of mean \sqrt{1−βₜ}xₜ₋₁ and variance βₜ is operated to produce xₜ. In (1) and (2), x₀ gradually loses the distinguishable features as the noise level deepens. This recursion can be formulated explicitly using the re-parameterization trick as follows:

$$q ( {x}_{t} \vert {x}_{0} ) = 𝒩 ( {x}_{t} ; \sqrt{{\hat{α}}_{t}} {x}_{0} , ( 1 - {\hat{α}}_{t} ) I ) ⇒ \qquad ( 3 )$$

$${x}_{t} = \sqrt{{\hat{α}}_{t}} {x}_{0} + \sqrt{1 - {\hat{α}}_{t}} {z}_{t}$$

where

$${\hat{α}}_{t} = {\prod }_{i = 1}^{t} ( 1 - {β}_{i} )$$

and zₜ˜ [symbol] (0,I). Via (3), the latent noisy xₜ can be sampled at arbitrary time step, which is further used to calculate the tractable objective loss [symbol] .

The normality memorizing step 26 involves specific mechanisms to effectively capture and retain the normal patterns during the forward noise encoding process. FIG. 3 shows the schematic illustration of the normality memorizing step 26. Denote the code memories as [symbol] : {M₁, M₂, . . . , M_{T}}, where the t-th memory Mₜ∈ [symbol] ^{1×K×n} recording prototypical patterns from the noise encoding in t-th step. Denote each query

$${M}_{t}^{k} ∈ {ℝ}^{1 \times 1 \times n} ,$$

where k=1,2, . . . , K. The noise encoding result Xₜ∈ [symbol] ^{H×W×n} is output from a batch of images, where H, W, n are height, width, and the size of training batches, respectively. The normality memorizing step 26 serves two purposes: (1) transform the feature vector

$${X}_{t}^{i}$$

of size 1×1×n using the code memory Mₜ; (2) update the memory query

$${M}_{t}^{k}$$

of size 1×1×n using the feature map Xₜ.

As displayed in FIG. 3, the cosine similarity between each encoded vector

$${X}_{t}^{i}$$

and the code memory Mₜ is first calculated as follows:

$${w}_{t}^{i , k} = \frac{exp ( {( {M}_{t}^{k} )}^{T} {X}_{t}^{i} )}{{\sum }_{{k}^{′} = 1}^{K} exp ( {( {M}_{t}^{{k}^{′}} )}^{T} {X}_{t}^{i} )} \qquad ( 4 )$$

where

$${w}_{t}^{i , k}$$

is the corresponding weights after the Softmax function. By integrating the memory queries with corresponding weights, the transformed feature vector

$${\hat{X}}_{t}^{i}$$

taking into account all normal patterns is obtained:

$$\hat{{X}_{t}^{i}} = {\sum }_{{k}^{′} = 1}^{K} {w}_{t}^{i , {k}^{′}} {M}_{T}^{{k}^{′}} \qquad ( 5 )$$

Applying (4) and (5) to all encoded vectors in Xₜ result in a transformed feature map \hat{X}ₜ∈ [symbol] ^{H×W×n}, which is then added to Xₜ and fed into the next denoise sampling step. Similar to (4), the cosine similarity between each memory query

$${M}_{t}^{k}$$

and the encoded feature map Xₜ is then computed as follows:

$${v}_{t}^{i , k} = \frac{exp ( {( {M}_{t}^{k} )}^{T} {X}_{t}^{i} )}{{\sum }_{{i}^{′} = 1}^{H \times W} exp ( {( {M}_{t}^{k} )}^{T} {X}_{t}^{{i}^{′}} )} \qquad ( 6 )$$

and normalize

$${v}_{t}^{i , k}$$

considering the feature indices for the corresponding features of

$${M}_{t}^{k} :$$

$${v}_{t}^{′ i , k} = \frac{{v}_{t}^{i , k}}{{max}_{{i}^{′} ∈ {D}_{t}^{k}} {v}_{t}^{{i}^{′} , k}} \qquad ( 7 )$$

With the normalized weights in (7), the query in code memory Mₜ is updated as follows:

$${M}_{t}^{k} ← f ( {M}_{t}^{k} + {\sum }_{i ∈ {D}_{t}^{k}} {v}_{t}^{′ i , k} {X}_{t}^{i} ) \qquad ( 8 )$$

where f(·) denotes the L2 norm,

$${D}_{t}^{k}$$

denotes the indices of the multiple feature vectors nearest to

$${M}_{t}^{k}$$

according to (6).

In the normality memorizing step 26, a set of code memories obtained from the noise encoding step is integrated to establish consistent representations of normality for subsequent steps.

Lastly, the denoise memory-suppress sampling step 28 is a reverse process approximating q(xₜ₋₁|xₜ) as in DDPM. When t=T, image samples with high fidelity should be reconstructed from isotropic Gaussian noise. Unlike the noise encoding step 24, the reconstruction requires the knowledge of all previous gradients, which can only be obtained with a learning model. Thus, the denoise memory-suppress sampling step 28 aims to train a sub-network with learned parameters θ, thereby estimating p_{θ}(xₜ₋₁|fᵤ(xₜ)) based on the normality memorizing function ƒᵤ. It is formulated with mean and variance as follows:

$${p}_{θ} ( {x}_{t - 1} \vert {f}_{u} ( {x}_{t} ) ) = 𝒩 ( {x}_{t - 1} ; {μ}_{θ} ( {f}_{u} ( {x}_{t} ) , t ) , {\sum }_{θ} ( {f}_{u} ( {x}_{t} ) , t ) ) \qquad ( 9 )$$

where the mean function and the variance function are computed as in [19]:

$${μ}_{θ} ( {f}_{u} ( {x}_{t} ) , t ) = \frac{1}{\sqrt{{α}_{t}}} ( {f}_{u} ( {x}_{t}^{′} ) - \frac{1 - {α}_{t}}{\sqrt{1 - {\hat{α}}_{t}}} {z}_{θ} ( {f}_{u} ( {x}_{t} ) , t ) ) \\ {\sum }_{θ} ( {f}_{u} ( {x}_{t} ) , t ) = exp ( v log {β}_{t} + ( 1 - v ) log {\tilde{β}}_{t} ) \qquad ( 10 )$$

where α=1−β,

$${\tilde{β}}_{t} = \frac{1 - {\hat{α}}_{t - 1}}{1 - {\hat{α}}_{t}} {β}_{t} ,$$

v is a mixing vector via model predicting.

If one apply (9) in all T time steps, the trajectory from x_{T} to x₀ is:

$${p}_{θ} ( {x}_{T : 0} ) = p ( {x}_{T} ) {\prod }_{t = 1}^{T} {p}_{θ} ( {x}_{t - 1} \vert {f}_{u} ( {x}_{t} ) ) \qquad ( 11 )$$

Let the transformed features \hat{x}ₜ=fᵤ(xₜ). The objective of this module is to train the sampling function p_{θ}(xₜ₋₁|\hat{x}ₜ) with the loss function defined as the variational lower bound loss:

$$\begin{matrix}{ℒ}_{vlb} = {\sum }_{t = 0}^{T} {ℒ}_{t} \\ = {𝔼}_{q ( {x}_{0 : T} )} [ log \frac{q ( {x}_{1 : T} \vert {x}_{0} )}{{p}_{θ} ( {\hat{x}}_{T : 0} )} ] \\ = {𝔼}_{q} [ - log {p}_{θ} ( {x}_{0} \vert {\hat{x}}_{1} ) \to {ℒ}_{0} + \\ {\sum }_{t > 1} {D}_{KL} ( q ( {x}_{t - 1} \vert {x}_{t} , {x}_{0} ) ‖ {p}_{θ} ( {x}_{t - 1} \vert {\hat{x}}_{t} ) ) \to {ℒ}_{t > 1} + \\ {D}_{KL} ( q ( {x}_{T} \vert {x}_{0} ) ‖ {p}_{θ} ( {x}_{T} ) ) ] \to {ℒ}_{T}\end{matrix} \qquad ( 12 )$$

where D_{KL} denotes the Kullback-Leibler divergence between two Gaussian distributions, which can be expressed in a closed-form. The first term [symbol] ₀ is modeled using a separate decoder, which is derived from [symbol] (x₀;μ_{θ}(\hat{x}₁,1),Σ_{θ}(\hat{x}₁,1)) as in [18]. The second term [symbol] _{t>1} ensures that at each time step t, the estimation of p_{θ}(xₜ₋₁|\hat{x}ₜ) is close to the true posterior of the q(xₜ₋₁|xₜ) as much as possible when conditioned on the input image. The last term [symbol] _{T} is constant since the encoding function q has no learnable parameters and x_{T} is a Gaussian noise. One can find in (12) that [symbol] _{T} does not depend on θ, implying that it can be ignored during training. Based on (12), an alternative loss function is employed to offer better reconstruction quality over [symbol] _{vlb}:

$${ℒ}_{s} = {𝔼}_{t ∼ [ 1 : T ] , {x}_{0} ∼ p ( {x}_{0} ) , {z}_{t} ∼ 𝒩 ( 0 , I )} [ {‖ {z}_{t} - {z}_{θ} ( {\hat{x}}_{t} , t ) ‖}^{2} ] \qquad ( 13 )$$

where [symbol] is the expected value, z_{θ}(\hat{x}ₜ,t) is the predicted noise in sampling step t.

The contrastive dissimilarity network 22 uses the input image and the reconstructed image to calculate correlation map and further predict the anomaly map. Inspired by [30], three components are involved in the contrastive dissimilarity network, including an encoder 30, a projector 32, and a fusion block 34 as shown in FIG. 2.

A pre-trained VGG is used as the encoder 30 to process both original input x₀ and the reconstruction p_{θ}(x₀), resulting in two embedding vectors. The two vectors are then projected by the projector 32 into a larger space with higher dimension d=1024. It is simply a three-layer perceptron with batch normalization and ReLU activation and learns the invariance of the two images. The design of the vector projection is common and crucial in CRL-based methods, since it is capable of squeezing all invariant information and preventing model collapse. The output of the projector are denoted as follows:

$${h}^{A} = {f}_{E , P} ( {x}_{0} ) ∈ {ℝ}^{d} \\ {h}^{B} = {f}_{E , P} ( {p}_{θ} ( {x}_{0} ) ) ∈ {ℝ}^{d} \qquad ( 14 )$$

Lastly, the fusion block 34 aims to compute the correlation map C(h^{A},h^{B}). Given the projector output, the correlation map is expected to be as close to the identity matrix as possible. For a batch size n,

$$C = \frac{{( {h}^{A} )}^{T} {h}^{B}}{n} ∈ {ℝ}^{d \times d}$$

is the empirical correlation map. The diagonal elements of target C (i.e., Cᵢᵢ) are equal to 1, forcing the embeddings invariant to the reconstruction. The off-diagonal elements of target C (i.e., Cᵢⱼ for i≠j) are equal to 0, which de-correlates the different components of embedding vectors and reduces the redundancy between h^{A} and h^{B}. With the fusion block, the network is directed to pay attention to high-dissimilar areas in the correlation map.

The objective function of the contrastive dissimilarity network 22 encompasses multiple components aimed at achieving effective differentiation between the input image and its corresponding reconstruction. Additionally, it involves a point-wise correlation with the high-level embedding vectors. The objective can be expressed through three distinct terms: reconstruction loss [symbol] _{rec}, projection feature loss [symbol] ₚᵣₒ, and contrastive loss [symbol] _{con}:

$$\begin{matrix}{ℒ}_{d} = {ℒ}_{rec} + {ℒ}_{pro} + {ℒ}_{con} \\ = {\sum }_{i}^{n} {‖ {x}_{0} - {p}_{θ} ( {x}_{0} ) ‖}_{2} + \\ λ {\sum }_{i}^{n} {‖ {h}^{A} - {h}^{B} ‖}_{2} + \\ {\sum }_{i} {( 1 - {C}_{ii} )}^{2} + {λ}_{con} {\sum }_{i} {\sum }_{i \neq j} {C}_{ij}^{2}\end{matrix} \qquad ( 15 )$$

where [symbol] _{rec} measures the L2 distance between the original images and their reconstructions, ensuring a faithful representation. [symbol] ₚᵣₒ calculates the L2 distance between the embedding vectors h^{A} and h^{B}. [symbol] _{con} plays a crucial role in balancing the trade-off between the invariance term and the redundancy reduction term. It consists of two components: (1) the sum of squared differences 1−Cᵢᵢ within the diagonal elements of the contrastive matrix C, which emphasizes the preservation of invariance, and (2) the sum of squared differences

$${C}_{ij}^{2}$$

for all non-diagonal elements (i≠j) of C, promoting redundancy reduction. [symbol] _{con} is the trade-off parameter controlling the invariance term and the redundancy reduction term.

Next, the training and testing of the ARLA in FIGS. 2-3 will be described. The training is a semi-supervised training, and during the training process, the memory-suppress diffusion module 20 and the contractive dissimilarity network 22 are jointly optimized to minimize the sum of [symbol] ₛ and [symbol] _{d}. The code memories are continuously updated to record the prototypical patterns of normal images. To speed up the sampling process, a multistep solution approximating the high-order derivatives is adopted, which is as what is recommended in [21].

The training of contrastive dissimilarity network also adopts a semi-supervised manner that does not rely on negative pairs. It incorporates a quantification mechanism to assess the degree of abnormality, enabling the differentiation between normal and anomalous images.

A key aspect of ARLA lies in its ability to achieve high-fidelity reconstruction. A weighted dissimilarity score ξ(x) is defined to express the RFOD at image-level:

$$ε ( x ) = {\sum }_{i , j} {W}_{ij} ( {x}_{0} , {p}_{θ} ( {x}_{0} ) ) {‖ {x}_{0}^{ij} - {( {p}_{θ} ( {x}_{0} ) )}^{ij} ‖}_{2} \qquad ( 16 )$$

where Wᵢⱼ is the weight function defined as follows:

$${W}_{ij} ( {x}_{0} , {p}_{θ} ( {x}_{0} ) ) = \frac{1 - exp ( - {‖ {x}_{0}^{ij} - {( {p}_{θ} ( {x}_{0} ) )}^{ij} ‖}_{2} )}{{\sum }_{i , j} 1 - exp ( - {‖ {x}_{0}^{ij} - {( {p}_{θ} ( {x}_{0} ) )}^{ij} ‖}_{2} )} \qquad ( 17 )$$

The above determines the relative significance of each term and allows the ARLA to focus more on the regions with high dissimilarity. Meanwhile, a threshold ζ is empirically decided to minimize the errors corresponding to false alarms and miss-detected anomalies. A small ξ(x) indicates a normal input while a large ξ(x) exceeding ζ for an anomalous input.

Once the testing sample is determined as anomalous, a stacked pixel-wise anomaly map is generated by merging a score distance map Mₛ and a feature distance map M_{d} along the depth dimension. The two maps are defined as follows:

$${M}_{s} = {W}_{ij} ( {x}_{0} , {p}_{θ} ( {x}_{0} ) ) {‖ {x}_{0}^{ij} - {( {p}_{θ} ( {x}_{0} ) )}^{ij} ‖}_{2} ∈ {ℝ}^{H \times W} \\ {M}_{d} = ω {‖ F ( {x}_{0} ) - F ( {p}_{θ} ( {x}_{0} ) ) ‖}_{2}^{2} \qquad ( 18 )$$

where Mₛ is derived from the dissimilarity score. M_{d} is derived from the encoded feature maps in contrastive dissimilarity network. F denotes the last activation layer before feature flattening. ω is the MSE weight to explore the effect of M_{d}.

Next, an analysis of the complexity of the ARLA in training is provided. As the ARLA is composed of a memory-suppress diffusion module and a contrastive dissimilarity network, its training complexity is described as follows. Let g₁(·) denote the complexity of memory-suppress operation, the complexity of the memory-suppress diffusion with K code memories within T steps over N training iterations is described as f_{MDM}∈O(N·T·g₁(K)^{T}). Let g₂(·) denote the complexity of convolution operation and Cₗ denote the output channels of l-th layer, the complexity of contrastive learning process of dissimilarities within D layers over N training iterations is described as

$${f}_{CDN} ∈ O ( N \cdot {\sum }_{l}^{D} {g}_{2} ( {C}_{l - 1} {C}_{l} ) ) .$$

Combining these two parts involves considering the composition and interactions of each part, such as the determination of anomalous sample at image-level.

In the following sections, firstly the railway dataset and setups employed during training and testing is introduced. Then, some properties of ARLA are shown and compared with state-of-the-art methods on pixel-wise RFOD. Finally, discussions on the components of ARLA are provided.

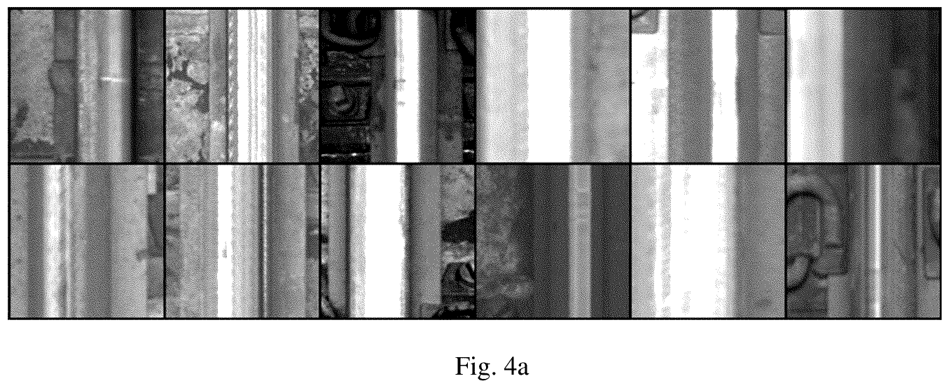

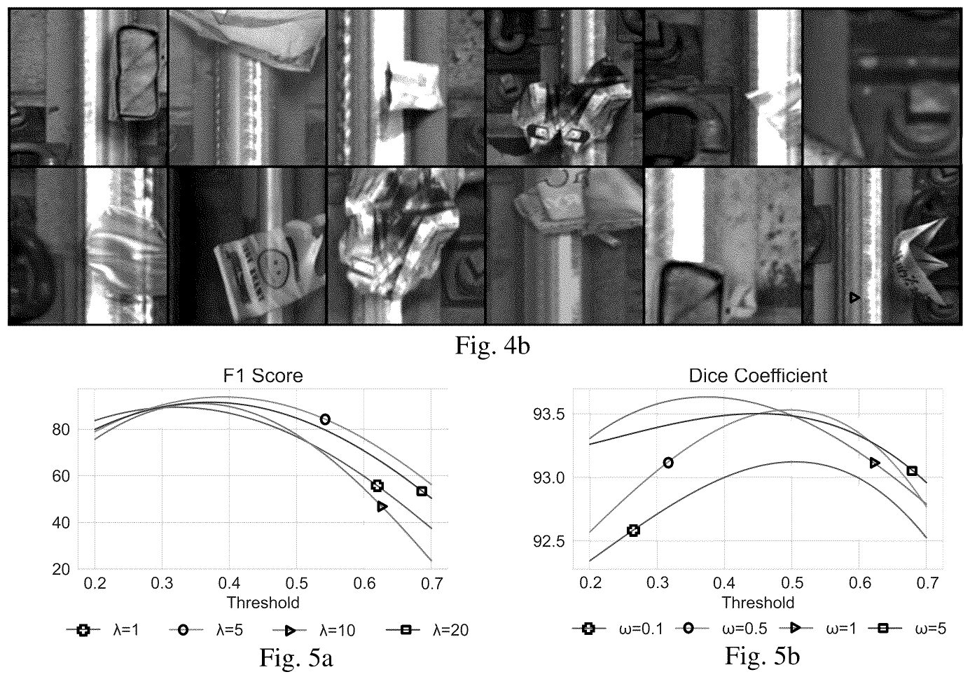

The railway dataset used in the experiments was collected by the Hong Kong Metro Corporation (MTR) via industrial cameras. A selection of collected samples is presented in FIGS. 4a and 4b. The dataset comprises two main subsets: Dₜᵣₐᵢₙ, consisting of normal images intended for training and shown in FIG. 4a, and Dₜₑₛₜ, which includes images with anomalies intended for testing and shown in FIG. 4b.

All images are labeled at the image level. Dₜᵣₐᵢₙ consists of 6656 normal images. Dₜₑₛₜ comprises 541 anomalous images and 490 normal images. To select the optimal hyperparameters during training, a small portion of Dₜₑₛₜ is reserved as the validation set Dᵥₐₗ, which consists of 120 anomalous images and 100 normal images. Apart from the image-level labels, pixel-wise annotations as ground truths for training are not provided. The anomalies manifest themselves in the form of over 10 different classes of foreign objects, such as phones, bags, and umbrellas. Prior to being fed into the ARLA model for training and testing, each image is resized to a resolution of 256×256 and normalized to values between 0 and 1. Furthermore, the images are converted to grayscale.

The training process for the memory-suppress diffusion module involves utilizing Dₜᵣₐᵢₙ to learn the normal patterns and update the code memories. In this regard, a setting T=50 is applied into the noise encoding and sampling steps based on experimental trials. The variance scheduler βₜ is defined in the range of [0.0001, 0.02] as recommended in [19]. In the contrastive dissimilarity network, the encoder and projector are initialized using Xavier initialization. The hidden dimension of the projector output is set to 1024. Grid searches are conducted to determine the optimal weights for the hyperparameters λ and ω, aiming to achieve the best performance based on Dᵥₐₗ. Additionally, the value of λ_{con} is set to 5×10⁻³ according to [30].

The entire pipeline of ARLA is trained end-to-end using the hybrid loss objective composed of [symbol] ₛ and [symbol] _{d}, with an AdamW optimizer (β₁=0.9, β₂=0.99). The initial learning rate of 5×10⁻⁴ and the weight decay of 10⁻⁴ are adopted. The default training schedule is 300 k iterations, with the learning rate divided by 10 at 200 k and 250 k iterations. All modules are trained with a batch size of 24 on three NVIDIA GeForce RTX 2080 GPUs.

At the inference stage, the image is noise encoded and denoised back within 50 steps. Following the reconstruction, dissimilarity score ξ and an anomaly map M is calculated. The threshold ξ is determined based on Dᵥₐₗ such that any image with ξ larger than ζ is identified as anomalous. The batch size at inference stage is set to 1.

Two distinct sets of evaluation metrics are employed to assess the detection performance of ARLA and benchmarking methods in the study. The first set encompasses commonly used metrics Precision, recall, and F1 score for image-level RFOD. The second set of evaluation metrics including dice coefficient and mean intersection over union (mIoU) evaluates the pixel-wise detection performance. Moreover, the model complexity in terms of parameters, FLOPs, inference time, and FPS are also considered.

Afterwards, experiments are performed to evaluate the sensitivity of two hyperparameters: A and a, which govern the impact of projection feature loss and feature distance map on image-level and pixel-wise detections, respectively. FIGS. 5a-5b illustrate the performance of the ARLA model in terms of the F1 score and dice coefficient based on different hyperparameter configurations. Results show that the ARLA model achieves its peak F1 score with λ=5 and ω=1. Intriguingly, a remarkable consistency is observed in the optimal thresholds obtained across both groups of experiments, with minimal variance. A threshold ξ=0.4 is selected as a better performance is achieved based on the validation dataset Dᵥₐₗ. These selected hyperparameters are subsequently employed for evaluation on Dₜₑₛₜ.

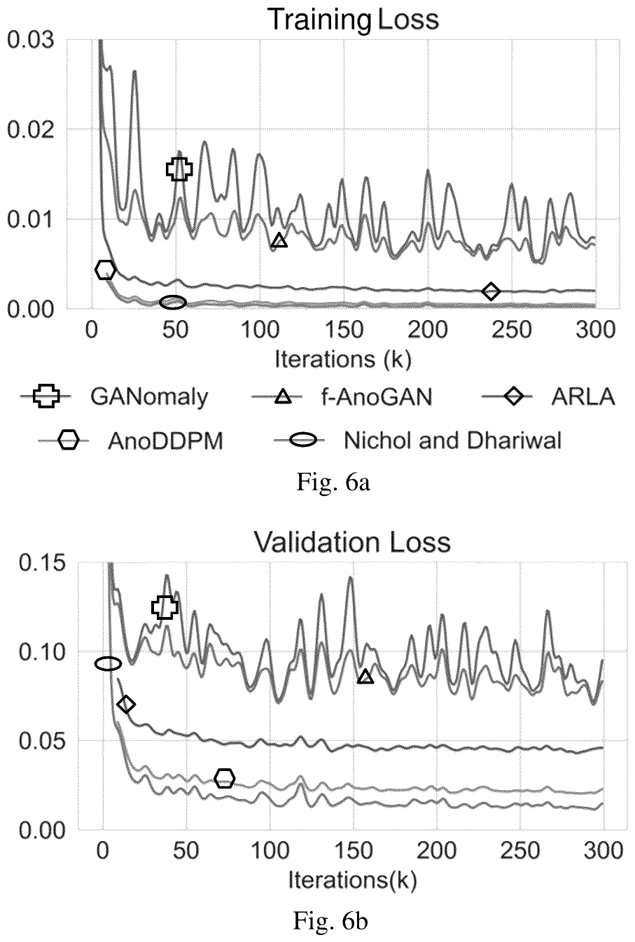

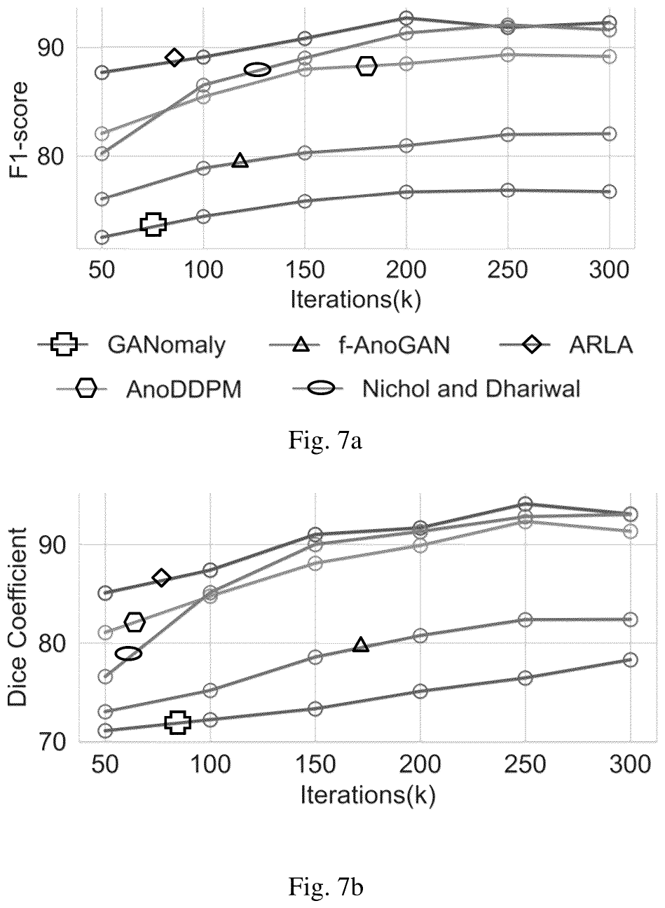

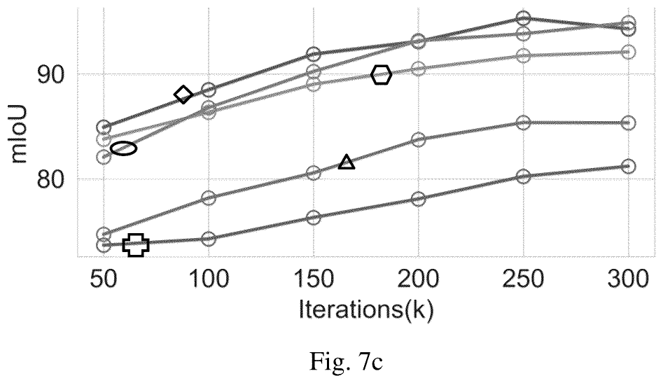

The ARLA is compared against two groups of benchmarking methods. The first group includes two GAN-based methods: f-AnoGAN [13] and GANomaly [14]. The second group involves two DDPM-based methods: Nichol and Dhariwal [19] and AnoDDPM [20]. FIGS. 6a and 6b display respectively the training loss and validation loss throughout the 300 k iterations. Default settings are adopted for all benchmarking methods. In FIG. 6a, it is first observed that the training losses of GANomaly and f-AnoGAN exhibit significant fluctuations after 30 k iterations while still showing a decreasing trend, whereas the training loss of the other three methods remains relatively stable. This indicates the necessity of continuing the training after the sudden drop in loss values. Second, in FIG. 6b the validation loss values of these five methods also show a gradual decline as the number of iterations increases, especially for GANomaly and f-AnoGAN. After 100 k iterations, their validation loss values experience noticeable fluctuations and then level off. FIGS. 7a-7c further illustrate the validation performance of ARLA and benchmarking methods. Results demonstrate a clear trend that the training iterations higher than 30 k lead to discernible improvements in performance metrics while the performance becomes stable after 300 k training iterations. Another finding is that most of the methods have reached the optimal performance before the end of training. Therefore, during the inference stage, the model weights achieving the optimal validation performance is exploited to detect anomalies in Dₜₑₛₜ.

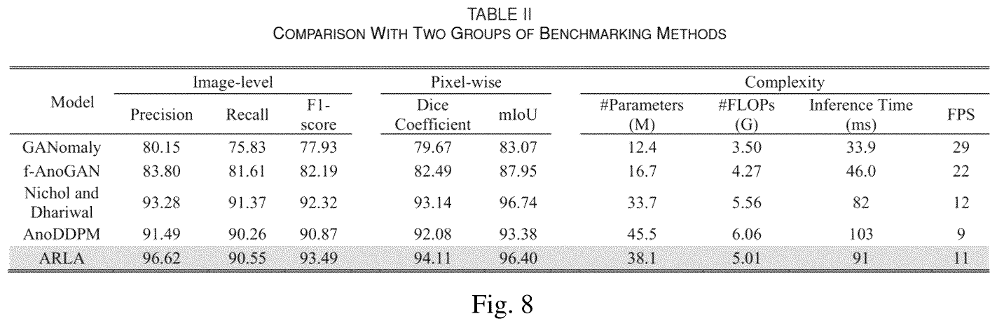

Quantitative comparison based on Dₜₑₛₜ with respect to image-level and pixel-wise metrics are represented in Table II which is shown in FIG. 8. Initially, ARLA is compared against the two GAN-based methods. Within this sub-group, ARLA outperforms the previous methods, particularly in pixel-wise detection, where the dice coefficient and mIoU exhibit significant improvements. Subsequently, the ARLA is compared against the DDPM-based methods, which require pixel-wise annotations during training. Given the imbalance between normal and anomalous samples, Dₜᵣₐᵢₙ and Dᵥₐₗ are combined to form the training set for the DDPM-based methods. By simply evaluating the difference between reconstructions and the ground-truths, the anomalous images are identified with highlighted pixels via DDPM-based methods. Table II shows that the ARLA achieves a noteworthy 2.6% improvement in F1 score, while maintaining comparable performance in terms of dice coefficient and mIoU. Notably, the method of ARLA involves fewer steps in the memory-suppress diffusion module than AnoDDPM, resulting in faster reconstruction progress during the inference stage. Finally, their FLOPs, total number of parameters, inference time, and FPS of the ARLA and benchmarks are summarized in Table II to provide a more intuitive representation of their complexity. The results indicate that GAN-based methods require significantly less time and computational resources compared to DDPM-based methods. Among the DDPM-based methods, the ARLA demonstrates reasonable parameter volume and testing time while showing a certain advantage in terms of FLOPs.

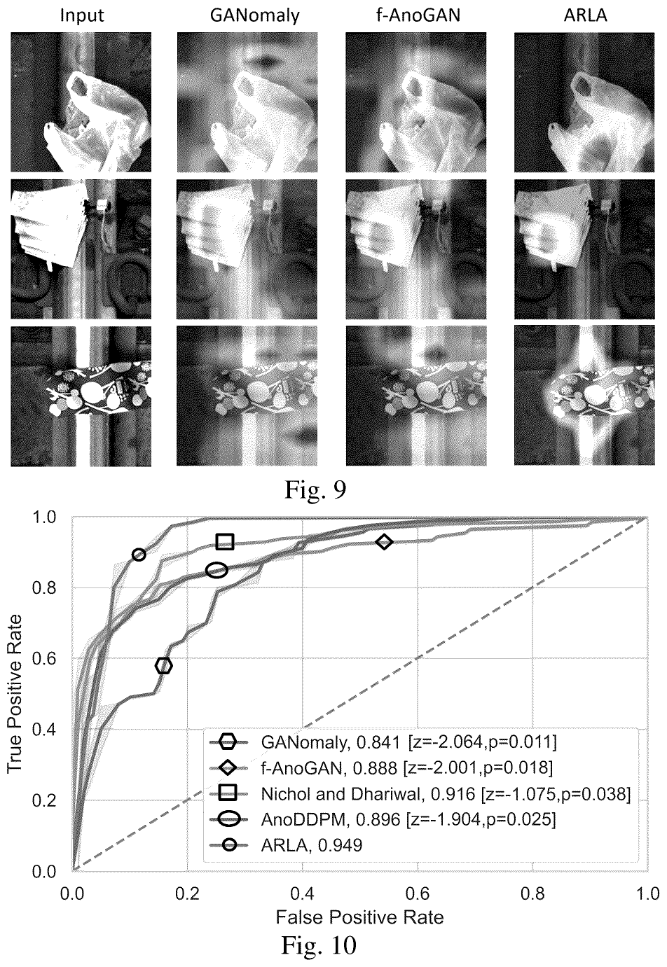

The network weights of the contrastive dissimilarity network in ARLA as well as those of two GAN-based methods are demonstrated. FIG. 9 provides valuable insights into the ability of each method to capture and localize anomalous regions based on testing images. While ARLA predominantly focuses on highly concentrated anomalous regions, the GAN-based methods tend to highlight partially normal regions as well. This divergence in focus is reflected in the corresponding metrics, such as the dice coefficient and mIoU, as elucidated in Table II. The visualization comparison underscores the efficacy of ARLA in capturing dissimilarities between the input and its reconstruction, thereby facilitating precise pixel-wise localization of anomalies.

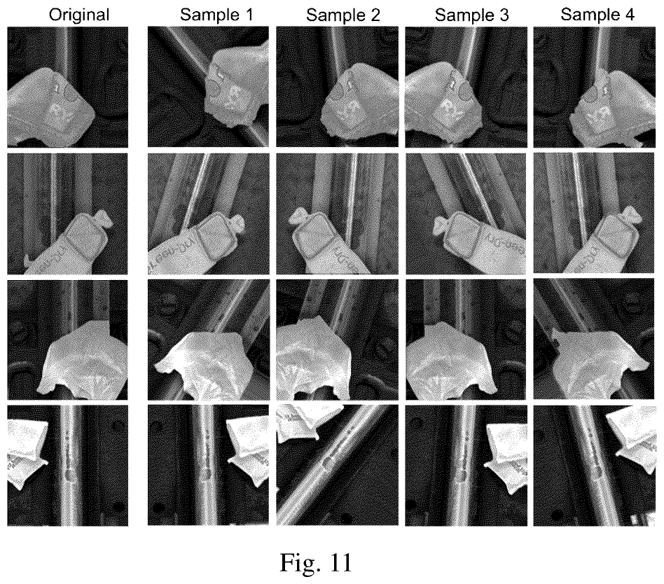

Statistical significance tests are essential for confirming the effectiveness of the model. In this section, DeLong's test [31] is incorporated for comparing the ROC curves and the area under ROC curves (AUROC) of all benchmarking methods. As shown in FIG. 10, the p-values of the four comparison groups are all smaller than a significance level of 0.05, indicating that the detection performance of benchmarking methods differs significantly from the proposed ARLA. When comparing ARLA with Nichol and Dhariwal, it shows a slightly higher p-value than the other groups. Adjusting the significance level will affect which groups are deemed significantly different. Nevertheless, a significance level of 0.05 is commonly used for conservative significance tests.

TABLE III
ABLATION STUDIES ON EACH COMPONENT
(a)

| T | F1 | Dice Coefficient | mIoU |
|---|---|---|---|
| 10 | 53.41 | 54.80 | 60.72 |
| 30 | 72.95 | 75.14 | 78.39 |
| 50 | 93.49 | 94.11 | 96.40 |
| 100 | 93.57 | 95.01 | 96.33 |

(b)

| | Memory- | | Dice | |
|---|---|---|---|---|
| DDPM | suppression | F1 | Coefficient | mIoU |
| | | 81.07 | 84.50 | 84.73 |
| ✓ | | 2.6 | 0.37 | 0.26 |
| ✓ | ✓ | 93.49 | 94.11 | 96.40 |

(c)

| score | feature | | Dice | |
|---|---|---|---|---|
| dist. map | dist. map | F1 | Coefficient | mIoU |
| | | 79.88 | 81.26 | 80.43 |
| ✓ | | 92.57 | 92.18 | 93.05 |
| | ✓ | 91.22 | 91.36 | 92.00 |
| ✓ | ✓ | 93.49 | 94.11 | 96.40 |

Comprehensive ablation studies are conducted on Dₜₑₛₜ to thoroughly analyze the individual contributions of the components in the proposed ARLA. The results are summarized in Table III, where the default settings of ARLA are marked in gray. First, the impact of sampling steps in the memory-suppress diffusion module is investigated. Table III(a) demonstrates that a sampling step value of 50 achieves a comparable F1 score, outperforming other groups by up to 40%. It is evident that ARLA requires a sufficient number of sampling steps to achieve the high-fidelity reconstruction of input images. However, excessive sampling steps result in the minimal improvement in fidelity while consuming more time and affecting mIoU during the inference stage. As a result, the sampling step value is set as T=50 to strike a balance between speed and quality in RFOD.

Furthermore, the effectiveness of the memory-suppression strategy is validated, as shown in Table III(b). When evaluating ARLA without the utilization of DDPM, normal images are directly fed into the contrastive dissimilarity network to learn the normal patterns between different images. The findings indicate that the performance of ARLA significantly degrades in the absence of both DDPM and memory-suppression. Moreover, ARLA struggles to identify anomalous images when only DDPM is employed without the memory-suppression strategy, highlighting the necessity of incorporating memory-suppression in ARLA for effective detection performance.

In addition, different distance maps are investigated in Table III(c), including a score distance map Mₛ and a feature distance map M_{d}. The experimental results demonstrate that combining these two maps yields the best performance for pixel-wise RFOD.

In addition, the promoting effect of data augmentation techniques on the ARLA framework is explored. One set of experiments was based on traditional data augmentation, including geometric transformations (flipping, cropping, rotation, and stretching) and color space transformations (brightness change and saturation change), resulting in an enhanced version ARLA-AUG. Another set of experiments utilize advanced data augmentation, Moment Exchange [32], leading to another model version named ARLA-ME. Additionally, a larger dataset D_{aug} is constructed using traditional data augmentation techniques to examine the detection capabilities of these models when faced with more complex samples. To offer a visual representation of the findings, FIG. 11 is presented that showcases samples from D_{aug} and elucidates their corresponding visualized detection results.

The assessment based on Dₜₑₛₜ and D_{aug} with quantitative insights are summarized in Table IV. It is found that even on a larger dataset D_{aug}, the detection prowess of the ARLA series models remains impressively robust. Furthermore, the comparative analysis between ARLA-AUG and ARLA-ME yields noteworthy insights. While ARLA-AUG fails to manifest substantial improvements in both image-level and pixel-level detection, ARLA-ME emerges as a compelling alternative. Notably, in the context of D_{aug}, ARLA-ME achieves a remarkable 2.1% enhancement in both dice coefficient and mIoU. These results discernments distinctly underscore the scalability advantages inherent to the ARLA framework when faced with larger datasets and the intricacies of more complex railway environments.

TABLE IV
EXPERIMENTAL RESULTS BASED ON Dₜₑₛₜ AND D_{aug}

| | | Data augmentation | | F1- | Dice | |
|---|---|---|---|---|---|---|
| | Model | Traditional | Advanced | score | Coefficient | mIoU |
| Dₜₑₛₜ | ARLA | | | 93.49 | 94.11 | 96.40 |
| | ARLA- | ✓ | | 93.28 | 94.50 | 96.42 |
| | AUG | | | | | |
| | ARLA- | ✓ | ✓ | 94.36 | 95.47 | 98.23 |
| | ME | | | | | |
| D_{aug} | ARLA | | | 92.65 | 93.89 | 96.21 |
| | ARLA- | ✓ | | 93.00 | 94.19 | 96.58 |
| | AUG | | | | | |
| | ARLA- | ✓ | ✓ | 93.82 | 95.94 | 98.30 |
| | ME | | | | | |

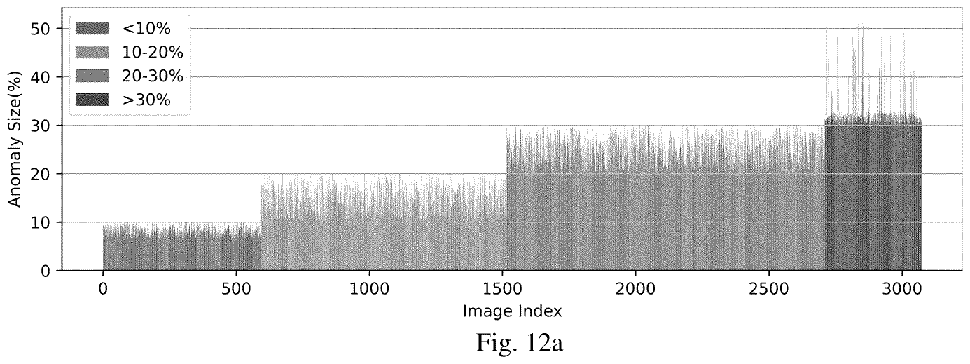

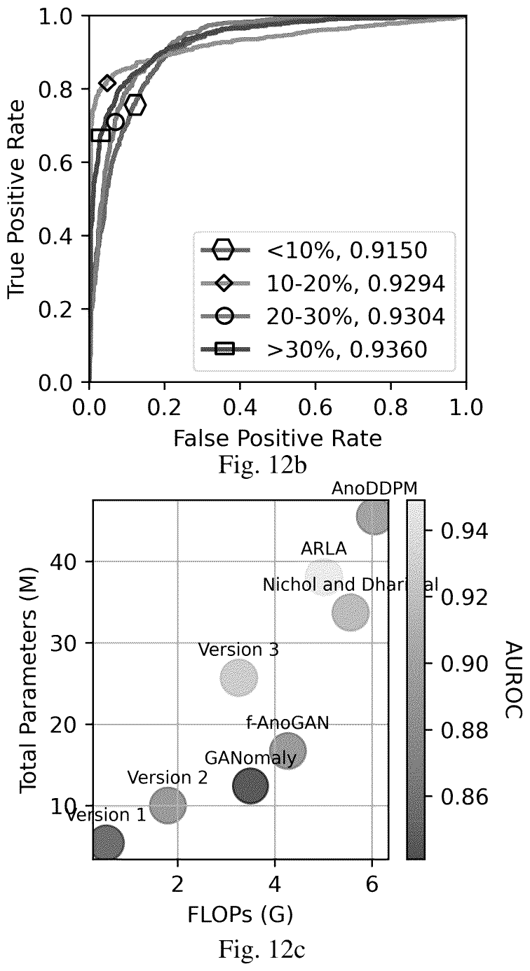

Severity Differentiation. Extensive experiments are conducted to validate the robustness of ARLA in detecting anomaly in different severity levels. In these experiments, the anomaly severity is defined as the proportion of anomalous pixels in the entire image. FIG. 12a depicts the distribution of anomaly sizes across 3138 anomalous images. The anomaly severity is categorized into four levels, <10%, 10%˜20%, 20%˜30%, and >30%. The majority of samples exhibit anomaly sizes ranging from 20-30%, indicating the prevalence of this size range in the dataset. Anomalies below 10% and between 10-20% occur less frequently, suggesting a lower incidence of smaller anomaly sizes. Anomalies exceeding 30% are relatively uncommon. FIG. 12b illustrates the discrimination ability of the ARLA across different anomaly severity levels. Impressively, ARLA demonstrates commendable detection performance even for small anomaly sizes, showcasing its versatility and robustness in detecting anomalies of varying magnitudes.

Data-free knowledge distillation method [33, 34] are explored, which derives lightweight model versions using the knowledge acquired from the original ARLA, to enhance the computational efficiency. FIG. 12c elucidates the trade-off between computational efficiency (represented by FLOPs and total parameters) and detection performance (measured by AUROC). The lightweight versions, Versions 1-3, demanding fewer computational resources tend to exhibit lower AUROC. However, it is noteworthy that ARLA consistently maintains superior detection performance across all lightweight versions, underscoring its efficacy in anomaly detection tasks. Meanwhile, it is noticed that Version 3 emerges as a promising solution that strikes a balance between accuracy and efficiency for the RFOD problem. The enhanced performance of Version 3 underscores the potential of computational efficiency optimization strategies in advancing anomaly detection systems.

In summary, the exemplary embodiment shown in FIGS. 2-3 presented a comprehensive investigation of image-level and pixel-wise RFOD without requiring anomaly samples in the context of anomalous railway scenes. A novel approach, the ARLA, is developed for classical railway foreign object detection task, which, in reality, was challenging to collect a sufficient amount of diverse anomaly samples. The ARLA included two complementary modules, a memory-suppress diffusion module and a contrastive dissimilarity network. ARLA offered several advantageous features, such as the less reliance on extensive anomalous data, ensuring a high-fidelity image reconstruction, and robustly performing RFOD with precise dissimilarity measurement. Through extensive experiments on a railway dataset, ARLA demonstrated superior performance compared to existing GAN-based and DDPM-based methods, positioning it as a potential solution for deployment in autonomous railway maintenance machines.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

For example, a person of ordinary skill in the art may realize that certain module(s) (for example the computing section) and method steps of the various examples described in connection with the embodiments disclosed herein may be realized by electronic hardware, computer software, or a combination of both, and in order to clearly illustrate the interchangeability of the hardware and the software, the module(s) and the steps of the various examples have been described in the foregoing description in general terms according to the functions. Whether these functions are performed in hardware or software depends on the particular application and design constraints of the technical solution. The skilled person may use different methods for each particular application to implement the described functions, but such implementations should not be considered outside the scope of the invention.

The functional units and modules that involve computations in accordance with the embodiments disclosed herein may be implemented using computing devices, computer processors, or electronic circuitries including but not limited to application-specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

The embodiments include computer storage media, transient and non-transient memory devices having computer instructions or software codes stored therein which can be used to program computers or microprocessors to perform any of the processes of the present invention. The storage media, transient and non-transitory computer-readable storage medium can include but are not limited to floppy disks, optical discs, Blu-ray Disc, DVD, CD-ROMs, magneto-optical disks, ROMs, RAMs, flash memory devices, or any type of media or devices suitable for storing instructions, codes, and/or data.

In the exemplary embodiments described above, it should be understood that the systems, devices and methods as disclosed may be realized in other ways. For example, the separation between internal components that are described above is merely a logical function separation, and in actual implementations the components may be separated in other ways, e.g., a plurality of units or components may be combined or may be integrated into another system, or some features may be ignored, or not implemented. Furthermore, coupling or direct coupling or communication connection between the units or components shown or discussed may also be indirect coupling or communication connection through some interface, device or unit, or may be connected electrically, mechanically or in some other form.

What is claimed is:

1. A computer-implemented system for foreign object detection in a scene; the system comprising:
a) a memory-suppress diffusion network module adapted to reconstruct a reconstructed image from an encoded image; the encoded image based on an input image; and
b) a contrastive dissimilarity network adapted to combine the input image and the reconstructed image to predict an anomaly map for the input image;
wherein the memory-suppress diffusion network module and the contrastive dissimilarity network are trained using only normal, real images.

2. The computer-implemented system of claim 1, wherein the memory-suppress diffusion network module further comprises:
c) a noise encoding module adapted to generate a plurality of noise-perturbed images from the input image;
d) a normality memorizing module adapted to integrate a set of code memories to establish consistent representations of normality; the set of code memories obtained from an output of the noise encoding module; and
e) a denoise memory-suppress sampling module adapted to reconstruct the reconstructed image from the consistent representations of normality using memory-suppression techniques.

3. The computer-implemented system of claim 2, wherein the plurality of noise-perturbed images is generated with a steadily increasing noise level.

4. The computer-implemented system of claim 2, wherein the noise levels of the plurality of noise-perturbed images follow a Markovian process, and sizes of steps of the noise levels are dominated by a variance scheduler.

5. The computer-implemented system of claim 2, wherein the noise encoding module is further adapted to sample a latent noisy at an arbitrary time step.

6. The computer-implemented system of claim 2, wherein the normality memorizing module is adapted to transform a feature vector associated with one said noise-perturbed image using a corresponding one of the code memories.

7. The computer-implemented system of claim 6, wherein during the transforming, the normality memorizing module is further adapted to compute a cosine similarity between the feature vector and the corresponding one of the code memories.

8. The computer-implemented system of claim 7, wherein a Softmax function is used to obtains weights in computation of the cosine similarity.

9. The computer-implemented system of claim 6, wherein the normality memorizing module is adapted to transform all the feature vectors associated with the plurality of noise-perturbed images to obtain a feature map.

10. The computer-implemented system of claim 2, wherein the normality memorizing module is adapted to update a memory query using a feature map.

11. The computer-implemented system of claim 2, wherein the denoise memory-suppress sampling module is adapted to reconstruct the reconstructed image using knowledge of all previous gradients.

12. The computer-implemented system of claim 1, wherein the contrastive dissimilarity network comprises:
f) an encoder adapted to encode the input image and the reconstructed image to obtain two embedding vectors;
g) a projector adapted to project the two embedding vectors to a larger space; and
h) a fusion block adapted to compute a correlation map from an output of the projector.

13. The computer-implemented system of claim 12 wherein the encoder is a pre-trained VGG (Visual Geometry Group) model.

14. The computer-implemented system of claim 13, wherein the projector is a three-layer perceptron with batch normalization and ReLU activation.

15. The computer-implemented system of claim 1, wherein the system is adapted to provide a weighted dissimilarity score to express the foreign object detection at image-level.

16. The computer-implemented system of claim 15, wherein the system is adapted to generate a stacked pixel-wise anomaly map by merging a score distance map and a feature distance map along a depth dimension.

17. The computer-implemented system of claim 1, wherein the memory-suppress diffusion module and the contrastive dissimilarity network are jointly optimized during training.

18. A computer-implemented method for detecting an foreign object, comprising the steps of:
a) encoding an input image to obtain an encoded image;
b) reconstructing a reconstructed image from the encoded image using a memory-suppress diffusion network module; and
c) combing the input image and the reconstructed image to predict an anomaly map for the input image;
wherein the memory-suppress diffusion network module and the contrastive dissimilarity network are trained using only normal, real images.

19. The computer-implemented method of claim 18, wherein Step a) further comprises a step of generating a plurality of noise-perturbed images from the input image.

20. The computer-implemented method of claim 18, wherein Step b) further comprises steps of:
d) integrating a set of code memories to establish consistent representations of normality; the set of code memories obtained from an output of Step a); and
e) reconstructing the reconstructed image from the consistent representations of normality using memory-suppression techniques.

21. The computer-implemented system of claim 18, wherein Step c) further comprises steps of:
f) encoding the input image and the reconstructed image to obtain two embedding vectors;
g) projecting the two embedding vectors to a larger space; and
h) computing a correlation map from an output of Step g).

22. A non-transitory computer-readable medium, having stored thereon program instructions that, upon execution by a computing device, cause the computing device to perform the method according to claim 18.

23. A computing system comprising:
a) one or more processors; and
b) memory containing instructions that, when executed by the one or more processors, cause the computing system to perform the method according to claim 18.
